(19) United States
(12) Patent Application Publication
(10) Pub. No.: US 2005/0128572 A1
(43) Pub. Date: Jun. 16, 2005

(54) Jig for microscopic inspection of bulk micro defects in single crystals

(76) Inventor: Jesse B. Griggs, Vancouver, WA (US)

Correspondence Address: SEH AMERICA, INC., M/S 58-1-921, 4111 N.E. 112TH AVE., VANCOUVER, WA, 98682, US

(21) Appl. No.: 10/734,478

(22) Filed: Dec. 12, 2003

(51) Int. Cl. G02B 21/18

(52) U.S. Cl. 359/373

(57) ABSTRACT

A jig for holding a Czochralski grown crystalline sample for optical microscopic inspection is disclosed. The jig can be mounted on another inspection jig typical of the semiconductor industry, or can be mounted directly on the base plate of the optical microscope. Spring tensioned clamps allow for fast and easy placement of the inspection sample into the jig, with the jaws being aligned parallel to one adjustment axis of the microscope to limit microscope adjustment to one axis.

### FIELD OF THE INVENTION

The present invention relates to inspecting monocrystalline semiconductor ingots, and more particularly to an apparatus for precisely holding a crystalline sample for inspection under a visual microscope.

### BACKGROUND OF THE INVENTION

Single crystal silicon, the starting material for the majority of microelectronic semiconductor components, is typically produced by the so-called Czochralski (CZ) process. In this process, polycrystalline silicon is placed in a crucible, typically made of quartz, and heated until the silicon reaches a molten state. A monocrystalline seed crystal containing the desired crystallographic properties is then lowered into the molten silicon and slowly extracted. At the beginning of the crystal growth process a technique is employed to remove crystallographic dislocations from the crystal generated from thermal shock when the seed crystal touches the melt. One such technique is growth of a neck using the dash technique well known in the industry. The diameter of the growing crystal is then increased until the desired diameter is obtained, wherein a monocrystalline ingot of a constant diameter is grown. At the completion of the growth process, the ingot diameter is then continually reduced basically to a point such that the crystal is separated from any remaining molten silicon, and the ingot is cooled under controlled circumstances and removed from the machine.

During crystal growth a purge gas such as argon or nitrogen, is introduced from the top of the crystal pulling apparatus and flows downward across the growing crystal, across the molten material, and is evacuated at the bottom of the apparatus. Due to the extreme temperature during crystal growth, the molten silicon reacts with the quartz in a small degree, with one of the byproducts being a silicon oxide gas which may deposit on interior parts of the apparatus, and may be undesirably added to the molten mass and grown into the crystal as an impurity.

The crystal pulling apparatus also has several moving parts. For example, the crucible typically rotates in one direction, and the seed crystal and consequently the crystal being grown, rotated in the opposite direction. Also, the growing crystal is supported and raised through the use of a cable, wire, rod or the like. Each of these processes, due to mechanical movement and interaction of parts, can cause small quantities of impurities to fall into the molten mass and be incorporated into the growing crystals.

Similarly, growth parameters such as the rate at which the crystal is pulled and the cooling rates and temperatures of the grown crystal must be controlled in order to avoid and/or control the presents of intrinsic point defects such as interstitials and vacancies.

As device fabrication on wafers produced from monocrystalline silicon continues to shrink in line width, it becomes ever more necessary to reduce contamination and crystalline defects. And, since the costs associated with fabricating integrated circuitry are very high, it becomes increasingly important to monitor and guarantee the quality of the crystal substrate. As such, there have been numerous tests designed to inspect a sample from a crystal for various defects, included but not limited to, those listed above. These tests may include items such as chemically etching, cleaning, annealing, preferential etching of a sample, and typically includes a visual inspection with the assistance of an optical microscope. In the case where a visual inspection is performed, it is common for an operator to qualify the types of defects and quantify the number of each type of defect found within a specific area (such as a 20 mm square area) taken from various samples throughout the crystal body.

In view of the foregoing therefore, the present invention is directed to a jig to allow an operator to quickly place a sample in a specific location relative to the microscope optics, and securely hold it while visual inspection is performed.

### BRIEF DESCRIPTION OF THE DRAWINGS

FIG. 1 depicts the bottom of a visual inspection jig that interfaces with a visual microscope table.

FIG. 2 depicts the top of a visual inspection jig that holds a crystal sample.

### DETAILED DESCRIPTION OF THE INVENTION

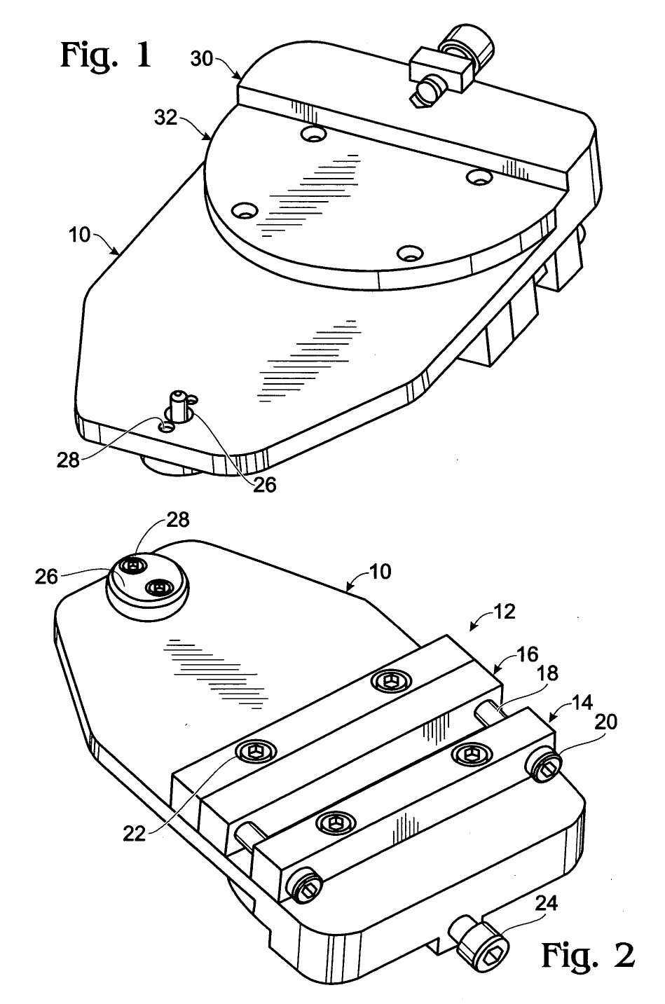

Turning now to FIG. 1, the base of the jig 10 is manufactured to interface with an optical microscope base stage, and/or another jig that may be utilized for inspection of other items. Pin 26 is designed to inset into a hole in a base stage or another jig (not shown) and act as a pivot point such that the jig 10 can be aligned with the front of the edge of the base stage. When the jig 10 is properly aligned, the ledge 30 will interface with and provide true alignment with the base jig. As shown in FIG. 2, the jig 10 can then be securely fixed to the base jig using a securing apparatus 24. In FIG. 2 the securing apparatus 24 is a set screw that can be tightened into the base jig, but does not need to be so limited. The securing apparatus 24 could also include other securing means including, but not limited to, a cam lock mechanism, a push pin (either with or without a spring loading), so long as the securing apparatus 24 is capable of securely holding the jig 10 to the base plate during use, but still capable of easily being removed when the microscope is needed for other purposes.

In the case where the jig 10 interacts with another jig instead of, or in addition to, the base plate, a jig interface ledge 32 may also be utilized, as shown in FIG. 1. In the example shown in FIG. 1, jig interface ledge 32 is semicircular and designed to represent the shape of a silicon wafer. This interface ledge 32 interacts with another jig not shown) specifically designed to hold silicon wafers for optical inspection. The advantage of an additional interface ledge allows for both a more securely held jig as well as saving time and effort from removing one jig to replace another.

FIG. 2 shows the top side of the jig 10, wherein the pin 26 is removably attached to the top side of the jig 10 with set screws 28 or the like, and extending through the bottom side of the jig to interface with a base stage or jig as previously explained. Optionally, the jig 10 can have multiple locations for which the pin 26 can be mounted to facilitate interfacing with multiple jigs or base plates as necessary.

A clamping bracket 12 and a mounting bracket 14 are secured to the top of the jig 10 by set screws or equivalent securing methods, with mounting bracket 14 having one or more holes bored therethrough running parallel to the main plate of the jig 10 and are optionally countersunk to allow clamping pin heads 20 to be partially recessed into mounting bracket 14. One or more clamping pins 18 extend through the holes bored into mounting bracket 14 and attach to a sliding clamp 16. A spring (not shown) is incorporated into one or more of the clamping pins 18, clamping pin heads 20, and the sliding clamp 16, with the spring placed such that it will exert force such that sliding clamp 16 is retractably forced toward clamping bracket 12. The spring may be placed between the clamping pin heads 20 and the mounting bracket 14 with the spring acting in tension when the clamping heads 20 are pulled away from the mounting bracket 14. Alternatively, a spring may be placed between the sliding clamp 16 and the mounting bracket 14, with the springs acting in compression when the clamping heads 20 are pulled away from the mounting bracket 14. In this option, the spring may be placed around the clamping pins, within the clamping pins 18, or the clamping pins themselves may serve as the springs. For the purpose of this disclosure, the term “spring” is meant to include any material with resilient elastic properties that will exert the force as outlined above, and may include such things as tension bands, coil springs, compression disks, and the like. Depending on the embodiment used, the clamping pins 18 and the clamping pin heads 20 may be detachably connected, or made of one solid piece.

When the clamping pin heads 20 are pulled away from the mounting bracket 14, the sliding clamp 16 will move away from mounting bracket 12 and toward mounting bracket 14, causing a gap to form therebetween for receiving a sample. After a sample has been placed in the gap, the clamping pin heads 20 are released, and the spring will cause the sliding clamp 16 to move back toward clamping bracket 12, ultimately contacting the sample placed within the gap. The spring force will then hold the sample to be inspected in a secure fashion between the clamping bracket 12 and the sliding bracket 16.

In the embodiment shown in the Figures, the ledge 30 is machined such that in runs parallel to one axis on the Cartesian coordinate system, i.e. parallel with the X-axis or the Y-axis. Similarly, the clamping bracket 12 and the mounting bracket 14 are mounted in parallel with the ledge 30, and are therefore parallel with one axis on the Cartesian coordinate system such that when a sample is held, inspection along an edge or surface of the sample may be checked by moving the microscope or the base stage along one adjustment axis only, thereby facilitating easier and faster microscope adjustments.

Although the invention has been described with reference to specific embodiments, other embodiments of the present invention will be apparent to those skilled in the art from a consideration of this specification or practice of the invention disclosed herein. It is intended that the written description be considered in all aspects only as illustrative and not restrictive. The scope of the invention is, therefore, indicated by the appended claims rather than by the foregoing description. All changes that come within the meaning and range of the equivalence of the claims are to be embraced within their scope.

1. A jig for holding a sample to be inspected on an optical microscope, the microscope being adjustable on a Cartesian coordinate system, comprising:
a plate;
a pin detachably mounted to the plate for interfacing with a base stage or second jig;
a ledge for aligning the plate with the base stage or second jig;
a securing apparatus;
a clamping bracket detachably mounted to the plate;
a mounting bracket detachably mounted to the plate;
a sliding clamp disposed between the clamping bracket and the mounting bracket;
at least one clamping pin attached to the sliding clamp, and passing through respective voids in the mounting bracket;
a clamping pin head detachably attached to each clamping pin; and
at least one spring for forcing the sliding clamp toward the clamping bracket.

2. The jig according to claim 1, wherein the spring is a compression spring located between the sliding clamp and the mounting bracket.

3. The jig according to claim 1, wherein the spring is a tension spring located between the mounting bracket and the clamping pin head.

4. The jig according to claim 1, wherein the ledge runs parallel with one axis on a Cartesian coordinate system with adjustments of the optical microscope.

5. The jig according to claim 4, wherein the clamping bracket and the mounting bracket run parallel with one axis on the Cartesian coordinate system with adjustments of the optical microscope.

6. The jig according to claim 1, further comprising a jig interface ledge for interfacing with the second jig.
